(19) United States
(12) Patent Application Publication
(10) Pub. No.: US 2020/0369088 A1
(43) Pub. Date: Nov. 26, 2020

(54) TIRE SHOULDER STRUCTURE

(71) Applicant: The Goodyear Tire & Rubber Company, Akron, OH (US)

(72) Inventors: Brian David Digman, Sagamore Hills, OH (US); Jan Frans Leyssens, Leglise-Beheme (BE); Pascal Pletschette, Mullendorf (LU); Robin Moia, Metz (FR); Gilles Reichling, Vichten (LU)

(21) Appl. No.: 16/420,491

(22) Filed: May 23, 2019

(51) Int. Cl. B60C 11/01

(52) U.S. Cl. CPC B60C 11/01; B60C 2011/013

(57) ABSTRACT

A tire includes a tread portion for contacting a road surface, two shoulder portions on each axial side of the tread portion, two sidewall portions extending radially inward from the shoulder portions, two hoop-shaped bead portions, and a carcass layer folded over the bead portions from an axially inner side to an axially outer side of the tire thus stretching the carcass layer into a toroidal shape in the tire circumferential direction of the first tire. One of the shoulder portions includes a recessed portion for modifying air flow about the one shoulder portion.

### FIELD OF INVENTION

The present invention relates to a pneumatic or non-pneumatic tire and, particularly, a tread shoulder structure for improving air flow around the tire during use.

### BACKGROUND OF THE INVENTION

Traveling performance of a vehicle needs to be enhanced. Thus, various performances of tires also need to be enhanced, including fuel economy performance of tires. Lowering air drag on the tires may increase the fuel economy performance of the tires and the vehicle.

One conventional tire includes a plurality of tire protrusions and/or a plurality of tire recesses on a tire side portion, or tread shoulder, that constitutes a vehicle outer side. The tire may generate a suitable turbulent flow about the surface of the vehicle outer side (the surface of the vehicle outer side of the pneumatic tire). Aerodynamic performance may thus be enhanced dramatically over cases where the area was simply increased where the protrusions and/or recesses are provided. The tire protrusions and/or recesses may be disposed in a partial angular range in a tire circumferential direction. Thereby, turbulent air flow may be suitably generated and the aerodynamic performance enhanced. Additionally, the tire protrusions and/or recesses may constitute a plurality of rows formed in the tire radial direction disposed at a predetermined pitch in the tire circumferential direction.

### SUMMARY OF THE INVENTION

A first tire in accordance with the present invention includes a tread portion for contacting a road surface, two shoulder portions on each axial side of the tread portion, two sidewall portions extending radially inward from the shoulder portions, two hoop-shaped bead portions, and a carcass layer folded over the bead portions from an axially inner side to an axially outer side of the tire thus stretching the carcass layer into a toroidal shape in the tire circumferential direction of the first tire. One of the shoulder portions includes a recessed portion for modifying air flow about the one shoulder portion.

According to another aspect of the first tire, the one shoulder portion includes a spur-like protrusion extending radially outward and axially outward from the one shoulder portion.

According to still another aspect of the first tire, the one shoulder portion includes a step-like transition from the tread portion to the radially recessed portion.

According to yet another aspect of the first tire, the other shoulder portion includes a spur-like protrusion extending radially outward and axially outward from the one shoulder portion.

According to still another aspect of the first tire, the other shoulder portion includes a step-like transition from the tread portion to the radially recessed portion.

According to yet another aspect of the first tire, the one shoulder portion includes a lug groove extending axially into the radially recessed portion.

According to still another aspect of the first tire, the one shoulder portion includes a lug groove extending axially toward the radially recessed portion to a blind end.

A second tire in accordance with the present invention includes a tread portion for contacting a road surface, two shoulder portions on each axial side of the tread portion, two sidewall portions extending radially inward from the shoulder portions, two hoop-shaped bead portions, and a carcass layer folded over the bead portions from an axially inner side to an axially outer side of the tire thus stretching the carcass layer into a toroidal shape in the tire circumferential direction of the second tire. One of the shoulder portions includes a longitudinal groove, a longitudinal land portion extending axially from the longitudinal groove, and a spur-like protrusion extending radially outward and axially outward from the longitudinal land portion.

According to another aspect of the second tire, the other shoulder portion includes a spur-like protrusion extending radially outward and axially outward from the one shoulder portion.

According to still another aspect of the second tire, the other shoulder portion includes a step-like transition from the tread portion to the radially recessed portion.

According to yet another aspect of the second tire, the one shoulder portion includes a lug groove extending axially into the longitudinal groove.

According to still another aspect of the second tire, the one shoulder portion includes a lug groove extending axially toward the longitudinal groove to a blind end.

A third tire in accordance with the present invention includes a tread portion for contacting a road surface, two shoulder portions on each axial side of the tread portion, two sidewall portions extending radially inward from the shoulder portions, two hoop-shaped bead portions, and a carcass layer folded over the bead portions from an axially inner side to an axially outer side of the tire thus stretching the carcass layer into a toroidal shape in the tire circumferential direction of the third tire. One of the shoulder portions includes a step-like transition from the tread portion to a radially recessed portion and toward the sidewall portions.

According to another aspect of the third tire, the other shoulder portion includes a spur-like protrusion extending radially outward and axially outward from the one shoulder portion.

According to still another aspect of the third tire, the other shoulder portion includes a step-like transition from the tread portion to the radially recessed portion.

According to yet another aspect of the third tire, the one shoulder portion includes a lug groove extending axially into the radially recessed portion.

According to still another aspect of the third tire, the one shoulder portion includes a lug groove extending axially toward the radially recessed portion to a blind end.

### Definitions

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the center plane or equatorial plane EP of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density).

“Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane of the tire.

“Radial ply tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF THE DRAWINGS

The present invention will be described by way of example and with reference to the accompanying drawings, in which:

FIG. 1 is a schematic meridian cross-sectional view of an example tire for use with the present invention.

FIG. 2 is a schematic meridian cross-sectional view of another example tire for use with the present invention.

FIG. 3 is a schematic partial perspective view of a tread shoulder in accordance with the present invention.

FIG. 4 is another schematic partial perspective view of the tread shoulder of FIG. 3.

FIG. 5 is a schematic partial perspective view of another tread shoulder in accordance with the present invention.

FIG. 6 is another schematic partial perspective view of the tread shoulder of FIG. 5.

### DETAILED DESCRIPTION OF EXAMPLES OF THE PRESENT INVENTION

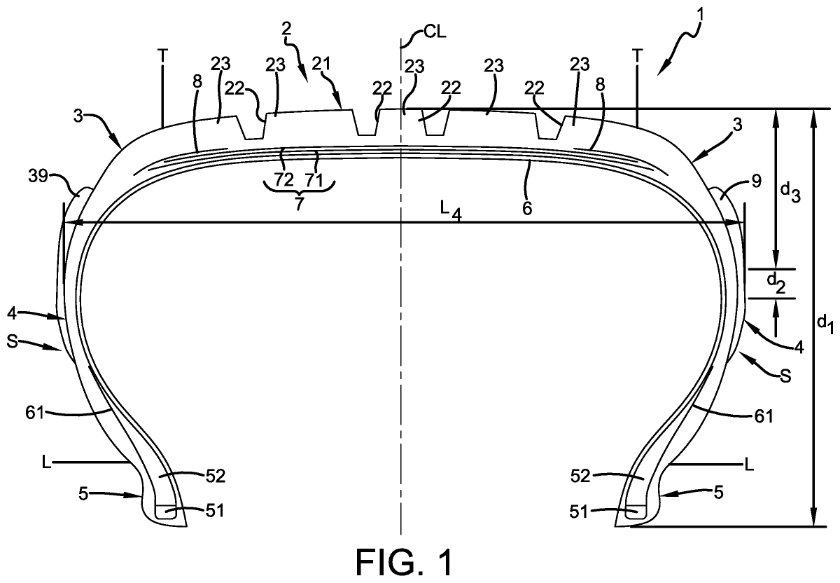

Examples of the present invention are described below in detail based on FIGS. 1-6. However, the present invention is not limited to these examples. The constituents of the examples may be replaced by those of ordinary skill in the art with similar alternate constituents. Furthermore, constituents of the examples may be freely combined within a scope of obviousness for a person of ordinary skill in the art.

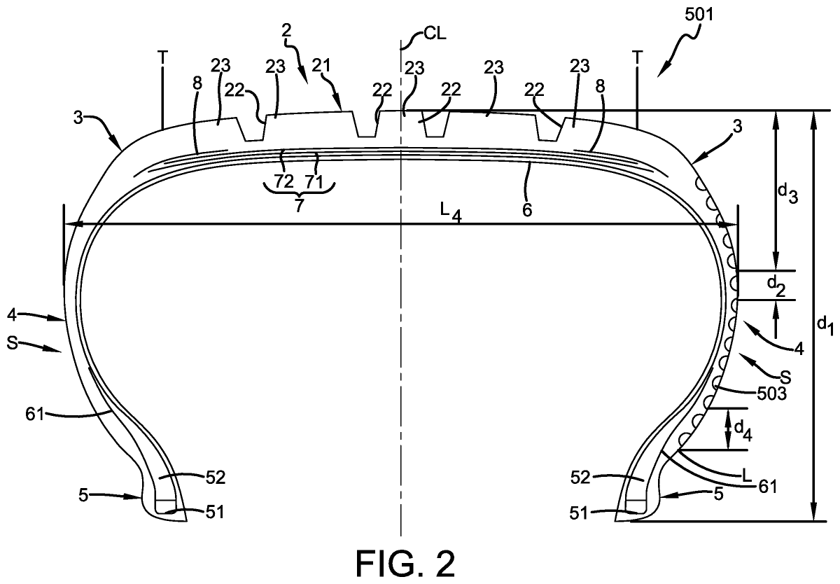

FIG. 1 is a schematic meridian cross-sectional view of an example pneumatic tire 1 for use with the present invention. FIG. 2 is a schematic meridian cross-sectional view of another example pneumatic tire 501 for use with the present invention. Such example tires 1, 501 are described in U.S. Pat. No. 9,132,694, herein incorporated by reference in its entirety.

As illustrated in FIG. 1, the example pneumatic tire 1 may include a tread portion 2, shoulder portions 3 on both sides of the tread portion 2, and a side wall portion 4 and a bead portion 5 continuing sequentially radially inward from each of the shoulder portions 3. The pneumatic tire 1 may further include a carcass layer 6, a belt layer 7, and a belt reinforcing layer 8. When in use, each of the bead portions 5 of the pneumatic tire 1 may be mounted on a rim portion of a wheel of a vehicle. A gas (e.g., air or nitrogen) may be injected into a tire internal space, or tire cavity, defined by the pneumatic tire 1 and the rim portion of the wheel.

The tread portion 2 may be formed from a rubber material and may be exposed on the outermost side in the tire axial direction of the pneumatic tire 1. A tread surface 21 may be formed on a peripheral surface of the tread portion 2 or, rather, on a road contact surface that contacts a road surface when traveling. The tread surface 21 may extend along the tire circumferential direction and four straight main grooves 22 parallel with an equatorial plane CL of the pneumatic tire 1.

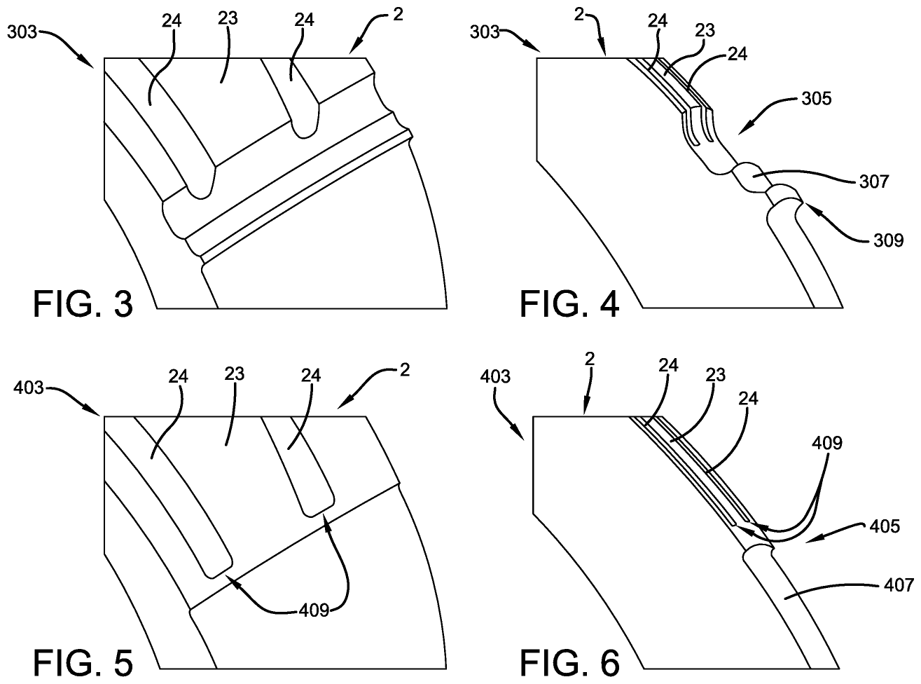

A plurality of rib-like land portions 23, extending along the tire circumferential direction and parallel with the equatorial plane CL, may be formed in the tread surface 21 by the plurality of main grooves 22. Transverse lug grooves 24 (FIGS. 3-6) may intersect with the main grooves 22 in each of the land portions 23 in the tread surface 21. The land portions 23 may be plurally divided in the tire circumferential direction by the lug grooves 24. The lug grooves 24 may open to an axially outer side of the tire 1 (FIGS. 3-4) or be closed before reaching the axially outer side of the tire (FIGS. 5-6). Further, the lug grooves 24 may communicate with the main grooves 22 or may be closed and not communicate with the main grooves.

The shoulder portions 3 may be disposed on both axially outer sides of the tire 1 (FIGS. 3-6, one shown). The side wall portions 4 may be disposed at the axially outer sides of the tire 1. The bead portions 5 may include a bead core 51 and a bead filler 52. The bead core 51 may be formed by winding a steel wire (e.g., bead wire, etc.) in a ring-like manner. The bead filler 52 may be a rubber material disposed in two spaces formed by ends 53 of the carcass layer 6 being folded or turned up at the bead cores 51.

The ends 61 of the carcass layer 6 may be folded over the pair of bead cores 51 from the axially inner side to the axially outer side of the tire 1 thus stretching the carcass layer into a toroidal shape in the tire circumferential direction of the tire. The carcass layer 6 may be formed by a plurality of carcass cords (not shown) juxtaposed in the tire circumferential direction along the tire meridian direction having a given angle with respect to the tire circumferential direction (e.g., from 85 degrees to 95 degrees) and covered by a coating rubber. The carcass cords may be formed from organic fibers (e.g. polyester, rayon, nylon, etc.) and/or steel.

The belt layer 7 may have a multi-layer structure where at least two layers (belts 71 and 72) are radially stacked. The belt layer 7 may be disposed on a radially outer side in of the carcass layer 6 and under a radially inner side of the tread portion 2. The belts 71 and 72 may be constituted by a plurality of cords (not shown) juxtaposed at a predetermined angle with respect to the tire circumferential direction (e.g., from 20 degrees to 30 degrees) and covered by a coating rubber. The cords of the belt layer 7 may be formed from steel or organic fibers (e.g., polyester, rayon, nylon, etc.). The overlapping belts 71 and 72 may be disposed such that the cords thereof mutually cross.

The belt reinforcing layer 8 may be disposed on a radially outer side of the belt layer 7. The belt reinforcing layer 8 may be constituted by a plurality of cords (not shown) juxtaposed substantially parallel (plus or minus—0.5 degrees) to the tire circumferential direction and covered by a coating rubber. The cords may be formed from steel or organic fibers (e.g., polyester, rayon, nylon, etc.). The example belt reinforcing layer 8 shown in FIGS. 1-2 may be disposed at two axially and radially outer portions of the belt layer 7. Alternatively, the belt reinforcing layer 8 may cover an entirety of the radially outer side of the belt layer 7. The belt reinforcing layer 8 may be formed by winding a band-like strip (e.g. with a width of 10 mm) in the tire circumferential direction.

In cases where the pneumatic tire 1 of these examples (FIGS. 1-2) is mounted on a vehicle (not shown), orientations with respect to an inner side and an outer side of the tire 1 may be designated. The orientation designations, for example, may be indicated on the side wall portions 4 (not shown). Hereinafter, a side of the tire 1 facing the inner side of the vehicle, when mounted on the vehicle, may be referred to as a “vehicle inner side” and a side of the tire facing the outer side of the vehicle may be referred to as a “vehicle outer side”. Designations of the vehicle inner side and the vehicle outer side may not be limited to cases when mounted on a vehicle. For example, in cases when assembled on a rim, orientation of the rim with respect to the inner side and the outer side of the vehicle may be set. Therefore, in cases when the pneumatic tire 1 is assembled on a rim, the orientation with respect to the inner side (vehicle inner side) and the outer side (vehicle outer side) of the tire 1 may be designated.

As shown in FIG. 1, a plurality of protrusions 9, axially protruding from the surface of the tire side portion S toward the outer side of the tire 1, may be provided on the tire side portion S of the vehicle outer side. Here, the “tire side portion S” refers to, in FIG. 3, the outer side in the tire width direction from a ground contact edge T of the tread portion 2 or, in other words, a surface that uniformly continues in a range of the outer side in the tire radial direction from a rim check line L. The “ground contact edge T” refers to both axially outermost edges of the tread surface 21 contacting the road surface when the tire 1 is assembled on a regular rim and filled with regular inner pressure and 70 percent of a regular load is applied. The ground contact edge T thereby continues in the tire circumferential direction. The “rim check line L” may refer to a line used to confirm whether the tire 1 has been assembled on the rim correctly and, typically, is an annular convex line closer to the outer side in the tire radial direction than a rim flange and continues in the tire circumferential direction along a portion adjacent to the rim flange on a front side surface of the bead portions 5.

The tire protrusions 9 may be formed as protrusions formed from a rubber material (may be the rubber material forming the tire side portion S or a rubber material different from the rubber material) formed with a longitudinal shape in the tire radial direction in a range of the tire side portion S, and may be disposed in the tire circumferential direction at a predetermined pitch.

Additionally, as illustrated in FIG. 1, a plurality of protrusions 39 axially extending from the surface of the tire side portion S may be provided on the tire side portion S of the vehicle inner side. The tire protrusions 39 may be formed from a rubber material (may be the rubber material forming the tire side portion S or a rubber material different from the rubber material) having a longitudinal shape in the tire radial direction in a range of the tire side portion S, and may be disposed in the tire circumferential direction at a predetermined pitch.

FIG. 2 shows a meridian cross-sectional view of another example tire 501 for use with the present invention. The tire 501 is fundamentally similar to the tire 1 of FIG. 1 except that tire recesses 503 replace the tire protrusions 9. Identical structures are given the same reference designations as FIG. 1. A plurality of tire recesses 503 may be formed in the tire side portion S of the pneumatic tire 501.

The tire recesses 503 may be disposed in a range of the tire side portion S at a predetermined pitch in the tire radial direction and the tire circumferential direction. The tire recesses 503 may be disposed in rows in the tire radial direction and the tire circumferential direction, respectively. One tire recess row may be formed from a plurality of the tire recesses 503 of the tire recesses disposed in a row in the tire radial direction. Additionally, because a plurality of the tire recesses 503 may be disposed in rows in the tire circumferential direction, the recess rows may have a configuration in which the recess rows are disposed in the tire circumferential direction. Note that in FIG. 2, the tire recesses 503 are provided in only the tire side portion S of the vehicle outer side, but may also be provided on the vehicle inner side (not shown).

Thus, air flow turbulence may be enhanced in the vicinity of the tire 501 due to the tire recesses 503. The air flow that flows on the side surface of the tire 501 may thus be converted to a state that flows easily along the side surface S in the vicinity of the tire 501. The air flow may thereby be retained as-is in the vicinity of the side surface S of the tire 501. As described above, air resistance, or drag, may be reduced and fuel economy may be enhanced even when the tire protrusions are replaced with the tire recesses 503 of the tire 501. Additionally, with the pneumatic tire 501, the tire recesses 503 may reduce rubber volume and heat dissipation may be improved due to enhancing the air turbulence while heat generation is suppressed. Therefore, tire heat buildup and temperature increases may also be suppressed.

The tire recesses 503 and the tire protrusions 9 may be formed in the same region of the tire side portion S. For example, at least a portion of the tire recesses 503 may be positioned apart from at least 10% or more of a tire cross-sectional height from a position where a tire cross-sectional width of the pneumatic tire 501 is greatest (position of maximum cross-sectional width L4) toward the outer side in the tire radial direction. That is, where d₁ is the tire cross-sectional height of the pneumatic tire 501, at least a portion of the tire recesses 503 may be formed in a region corresponding to a height d3 farther outward in the tire radial direction than an edge of the outer side in the tire radial direction of a region corresponding to a height d2 that is 10% of the tire cross-sectional height d₁ from a position where the tire cross-sectional width is greatest.

At least a portion of the tire recesses 503 may be disposed in a region from a rim check line to a position separated 10% of the tire cross-sectional height starting from the rim check line toward the outer side in the tire radial direction or, rather, the region corresponding to a height d4. By disposing a portion of the tire recesses 503 in the region corresponding to the height d4, heat dissipation in the pneumatic tire 501 may be further enhanced and air resistance may be reduced while suppressing heat buildup.

As shown in FIGS. 3-4, a first shoulder portion 303 in accordance with the present invention may replace the shoulder portions 3 of the tire 1 or the tire 501 of FIGS. 1-2. The first shoulder portion 303 may include a longitudinal groove 305, a longitudinal land portion 307 extending axially from the longitudinal groove, and a spur-like protrusion 309 extending radially outward and axially outward from the longitudinal land portion. The first shoulder portion 303 may produce an air flow enhancement similar to the protrusions 9 (FIG. 1) and recesses 503 (FIG. 2) described above. The first shoulder portion 303 may thus create desired air flow by modifying the transition from the cylindrical tread portion 2 radially inward toward the side surface(s) S of the tire 1 or 501. The lug grooves 24 may axially extend into the longitudinal groove 305.

As shown in FIGS. 5-6, a second shoulder portion 403 in accordance with the present invention may replace the shoulder portions 3 of the tire 1 or the tire 501 of FIGS. 1-2. The second shoulder portion 403 may include a step-like transition 405 from the tread portion 2 to a radially recessed portion 407 and toward the side surface(s) S of the tire 1 or 501. The second shoulder portion 403 may also produce an air flow enhancement similar to the protrusions 9 (FIG. 1) and recesses 503 (FIG. 2) described above. The second shoulder portion 303 may thus create desired air flow by modifying the transition from the cylindrical tread portion 2 radially inward toward the side surface(s) S of the tire 1 or 501. The lug grooves 24 may axially extend to blind ends 409 axially inward from the step-like transition 405.

Further variations in the present invention are possible in light of the description of it provided herein. While certain representative examples and details have been shown for the purpose of illustrating the subject invention, it will be apparent to those skilled in this art that various changes and modifications can be made therein without departing from the scope of the subject invention. It is, therefore, to be understood that changes may be made in the particular examples described which will be within the fully intended scope of the present invention as defined by the following appended claims.

What is claimed:

1. A tire comprising:
a tread portion for contacting a road surface;
two shoulder portions on each axial side of the tread portion;
two sidewall portions extending radially inward from the shoulder portions;
two hoop-shaped bead portions; and
a carcass layer folded over the bead portions from an axially inner side to an axially outer side of the tire thus stretching the carcass layer into a toroidal shape in the tire circumferential direction of the tire, one of the shoulder portions including a recessed portion for modifying air flow about the one shoulder portion.

2. The tire as set forth in claim 1 wherein the one shoulder portion includes a spur-like protrusion extending radially outward and axially outward from the one shoulder portion.

3. The tire as set forth in claim 1 wherein the one shoulder portion includes a step-like transition from the tread portion to the radially recessed portion.

4. The tire as set forth in claim 2 wherein the other shoulder portion includes a spur-like protrusion extending radially outward and axially outward from the one shoulder portion

5. The tire as set forth in claim 2 wherein the other shoulder portion includes a step-like transition from the tread portion to the radially recessed portion.

6. The tire as set forth in claim 1 wherein the one shoulder portion includes a lug groove extending axially into the radially recessed portion.

7. The tire as set forth in claim 1 wherein the one shoulder portion includes a lug groove extending axially toward the radially recessed portion to a blind end.

8. A tire comprising:
a tread portion for contacting a road surface;
two shoulder portions on each axial side of the tread portion;
two sidewall portions extending radially inward from the shoulder portions;
two hoop-shaped bead portions; and
a carcass layer folded over the bead portions from an axially inner side to an axially outer side of the tire thus stretching the carcass layer into a toroidal shape in the tire circumferential direction of the tire, one of the shoulder portions including a longitudinal groove, a longitudinal land portion extending axially from the longitudinal groove, and a spur-like protrusion extending radially outward and axially outward from the longitudinal land portion.

9. The tire as set forth in claim 8 wherein the other shoulder portion includes a spur-like protrusion extending radially outward and axially outward from the one shoulder portion.

10. The tire as set forth in claim 8 wherein the other shoulder portion includes a step-like transition from the tread portion to the radially recessed portion.

11. The tire as set forth in claim 8 wherein the one shoulder portion includes a lug groove extending axially into the longitudinal groove.

12. The tire as set forth in claim 8 wherein the one shoulder portion includes a lug groove extending axially toward the longitudinal groove to a blind end.

13. A tire comprising:
a tread portion for contacting a road surface;
two shoulder portions on each axial side of the tread portion;
two sidewall portions extending radially inward from the shoulder portions;
two hoop-shaped bead portions; and
a carcass layer folded over the bead portions from an axially inner side to an axially outer side of the tire thus stretching the carcass layer into a toroidal shape in the tire circumferential direction of the tire, one of the shoulder portions including a step-like transition from the tread portion to a radially recessed portion and toward the sidewall portions.

14. The tire as set forth in claim 13 wherein the other shoulder portion includes a spur-like protrusion extending radially outward and axially outward from the one shoulder portion.

15. The tire as set forth in claim 13 wherein the other shoulder portion includes a step-like transition from the tread portion to the radially recessed portion.

16. The tire as set forth in claim 13 wherein the one shoulder portion includes a lug groove extending axially into the radially recessed portion.

17. The tire as set forth in claim 13 wherein the one shoulder portion includes a lug groove extending axially toward the radially recessed portion to a blind end.
